(19) United States
(12) Patent Application Publication
(10) Pub. No.: US 2019/0135598 A1
(43) Pub. Date: May 9, 2019

(54) METHOD AND SYSTEM TO RETROFIT INDUSTRIAL LIFT TRUCKS FOR AUTOMATED MATERIAL HANDLING IN SUPPLY CHAIN AND LOGISTICS OPERATIONS

(71) Applicant: STOCKED ROBOTICS, INC., College Station, TX (US)

(72) Inventors: Saurav Agarwal, College Station, TX (US); Jacob Corder Currence, Austin, TX (US); Zoltan C. Bardos, Austin, TX (US)

(73) Assignee: STOCKED ROBOTICS, INC., College Station, TX (US)

(21) Appl. No.: 16/183,592

(22) Filed: Nov. 7, 2018

Related U.S. Application Data
(60) Provisional application No. 62/582,739, filed on Nov. 7, 2017.

(51) Int. Cl. B66F 9/06; G05D 1/00; G05D 1/02; B66F 9/075

(52) U.S. Cl. CPC B66F 9/063; B66F 9/07581; G05D 1/0291; G05D 1/0088

(57) ABSTRACT

Material handling vehicles also known as lift trucks, e.g., forklifts, pallet jacks, reach trucks etc., are an essential component of any supply chain and logistics operation. These vehicles are typically driven by human operators and are used to move goods inside factories, warehouses etc. We develop a system and method to retrofit manual lift trucks with a supplemental control system (retrofit kit) that includes sensors, communication devices, computers, electrical circuits and mechanical actuators such that a lift truck can carry out material handling tasks autonomously without the presence of a human operator. The retrofit also allows the lift truck to be controlled remotely by a human tele-operator and can transmit and receive data from a remote computer.

### RELATED APPLICATIONS

The present application claims priority to and benefit of U.S. Provisional Patent Application 62/582,739, which is hereby incorporated by reference for all purposes as if set forth herein in its entirety.

### TECHNICAL FIELD

The present disclosure relates generally to automated vehicles, and more specifically to a method and system to retrofit industrial lift trucks for automated material handling.

### BACKGROUND OF THE INVENTION

Automated vehicles are known, but are expensive and are usually incompatible with automated vehicles from different manufacturers.

### SUMMARY OF THE INVENTION

Material handling vehicles also known as lift trucks, e.g., forklifts, pallet jacks, reach trucks etc., are an essential component of any supply chain and logistics operation. These vehicles are typically driven by human operators and are used to move goods inside factories, warehouses etc. We develop a system and method to retrofit manual lift trucks with a supplemental control system (retrofit kit) that includes sensors, communication devices, computers, electrical circuits and mechanical actuators such that a lift truck can carry out material handling tasks autonomously without the presence of a human operator. The retrofit also allows the lift truck to be controlled remotely by a human tele-operator and can transmit and receive data from a remote computer.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 shows a graphical representation of various lift truck types;

FIG. 2 shows a block diagram of exemplary retrofit kit components and how they are interconnected for the purposes of sharing data;

FIG. 3 shows an example (embodiment) of how the retrofit kit components are mounted on a center rider pallet jack type lift truck;

FIG. 4 shows the mapping process flow diagram;

FIG. 5 shows how sensor data is uploaded to a remote server to train artificial intelligence models in one exemplary embodiment;

FIG. 6 shows the automatic docking process for charging;

FIG. 7 gives an exemplary visual description of how the obstacle detection system can work;

FIG. 8 shows an exemplary block diagram for how a remote operator can control a lift truck via a wireless link; and

FIGS. 9 and 10 show how the retrofit kit enables inventory tracking.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

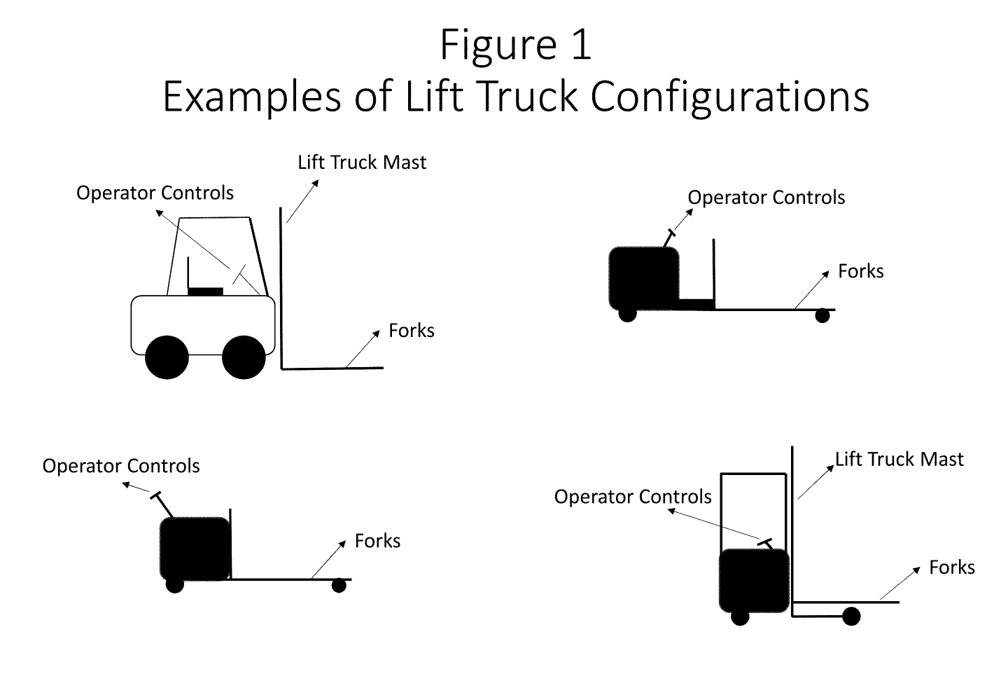

Material handling vehicles also known as lift trucks are used to move goods, e.g., pallets from one location to another. FIG. 1 shows a graphical representation of various lift truck types. These vehicles are typically driven or controlled by a human operator such as a warehouse or factory employee. A typical use case for a lift truck is to pick up a pallet using the forks of the lift truck from the ground or from a storage rack and then transporting the pallet to another location and depositing it on the floor or moving it vertically and positioning it into a rack. Other use cases include loading and unloading trailers or any pallet move required as part of a material handling operation. It is quite common for such moves to be repeated throughout a work shift, either between the same two physical locations or between various combinations of physical locations.

The method and system (retrofit kit) developed in this work allows lift trucks to operate autonomously without a human operator physically present on-board the vehicle. In other words, a lift truck is transformed into a driverless vehicle.

A retrofit kit comprising sensors, computers, communication devices, electrical circuits and mechanical actuators which allows lift trucks to operate autonomously without a human operator or via a remote tele-operator. In addition, the following are disclosed and claimed.

Sensors, computers, communication devices, electrical circuits and mechanical actuators are retrofitted to a lift truck and enabled by software such that sensor information is processed by software and used to drive the lift truck via electrical interfaces or through mechanical actuation.

Using a combination of software and sensors the lift truck is adapted to build an understanding of the physical layout of its environment, i.e., build a map of the operational environment with additional contextual information and then use that map and contextual information to navigate autonomously.

The map that is generated is adapted to be shared to other lift trucks in a fleet or to a remote server via a wireless link.

Lift truck is adapted to be operated in manual and autonomous mode via operator selection through a touch screen interface or a physical switch. In autonomous mode, missions can be defined via a web-based dashboard or a touch screen interface.

The lift truck is adapted to store sensor data and upload it to a remote server such that this data can then be used by Machine Learning and Artificial Intelligence software to learn and improve autonomy capability.

On board sensors are adapted to inform a human operator in real-time of proximity to obstacles to avoid injuries and damage. In case an accident is detected, a notification is sent out via a wireless link to a remote server and accident related data is stored in logs.

In manual mode, onboard sensors track driver behavior and alert managers of violations such as distracted or rash driving.

On board systems are adapted to log position, speed and vehicle diagnostic data in real-time and relay it to a remote human manager via a wireless link to enable preventative maintenance and ensure lift truck operator compliance with safe operation guidelines.

The lift truck is adapted to receive software updates via wireless (cellular or wifi) links and install it to the on-board computers such that additional intelligence capabilities can be added over time without taking the equipment out of service for long durations.

The lift truck is adapted to detect a low battery level and autonomously dock with a physical charging station till batteries are charged and then proceed with regular tasks.

The lift trucks is adapted to be operated remotely via a wireless link (cellular or wifi) such that a remote operator is sent the sensor data and in return the the remote operator uses a physical interface (PC, tablet, head mounted display, joysticks, physical buttons or a combination thereof) to process sensor data and operate the lift truck in order to pick up goods and drive them from one location to another.

A lift truck may alert a remote operator to take control for tasks that are not pre-programmed in the on-board software. This would allow the lift truck to leverage human intelligence for complex tasks.

A lift truck may detect a physical obstruction or unexpected anomaly based on sensor input. If on board software is not able to create a safe action, the lift truck will halt and alert nearby operators for assistance.

The lift truck may also alert a remote operator who will diagnose and remotely drive the lift truck till obstruction is clear.

The lift truck is equipped with bar code scanning capability such that it is adapted to scan the item being moved and communicate that information to a warehouse or inventory management system through a direct or indirect link via a software Application Programming Interface (API).

We now proceed to describe how exemplary components of a system in accordance with the present disclosure are configured to work together to enable automated material handling.

The following exemplary components can be used to comprise a retrofit kit that is mounted on-board a lift truck, in accordance with exemplary embodiments of the present disclosure, as discussed herein:

E-Stop (emergency stop) buttons can be mounted in various easy to reach places so that the vehicle can be stopped in the event of an emergency. Unlike emergency stop buttons on conventional equipment that are located near the operator's console, the present disclosure includes emergency stop buttons external to the equipment, or remote emergency stop controls.

An imaging sensor, such as a stereo camera pair mounted in one or more of the forward direction or other suitable directions, to perceive depth and detect obstacles.

An imaging sensor, such as a stereo camera pair mounted in one or more of the reverse direction or other suitable directions, to perceive depth and detect obstacles.

Ultrasonic range finders mounted on the body of the vehicle or in other suitable locations and configured to detect obstacles in a short range around the periphery of the vehicle.

Imaging sensors, such as a stereo camera pair or other suitable sensors mounted on the sides of the vehicle body or in other suitable locations and configured to detect objects laterally.

A LiDAR or Laser Range Measurement device or other suitable devices mounted on a mast that is adapted to measure range to physical features in the environment or in other suitable locations.

A LiDAR or Laser Range Measurement device or other suitable devices mounted in the front of the vehicle or in other suitable locations to detect range to obstacles.

An Inertial Measurement Unit or other suitable devices that is rigidly mounted on the lift truck or in other suitable locations.

A primary computer or other suitable data processor that processes sensor information and computes control actions.

A secondary computer or other suitable data processor that is configured to communicates information between the primary computer, sensors, actuators and the lift truck's electrical control systems or other suitable devices and systems.

Mechanical actuator or other suitable devices to turn the steering wheel if the steering wheel is not electrically actuated in the existing form prior to retrofit.

Mechanical actuators or other suitable devices to actuate accelerator and brake if acceleration and braking is not electrically actuated in the existing form prior to retrofit.

Linear Mechanical actuators or other suitable devices to control hydraulic interfaces to operate forks and mast in the case that these are not electrically actuated in the existing form prior to retrofit.

Printed circuit boards that distribute power to sensors, computers and actuators and communicate data between different components of the machine.

A circuit board that interfaces with an onboard CAN bus (if present) to send control signals and extract diagnostics information.

Bar code scanners or other suitable devices to read bar codes, NFC tags, RFID tags or other identification tags on pallets and goods.

A LiDAR mounted on the mast or in the fork mechanism or in other suitable locations to detect pallets.

A Stereo camera mounted on the lift truck mast or fork mechanism or in other suitable locations for perceiving objects in front of the forks.

Weight sensors on the forks or in other suitable locations to detect if pallet or goods are loaded.

Ceiling facing cameras to capture structural or artificially installed feature points on the ceiling and track them in order to increase positioning accuracy

A camera looking into the driver's cabin to monitor driver behavior.

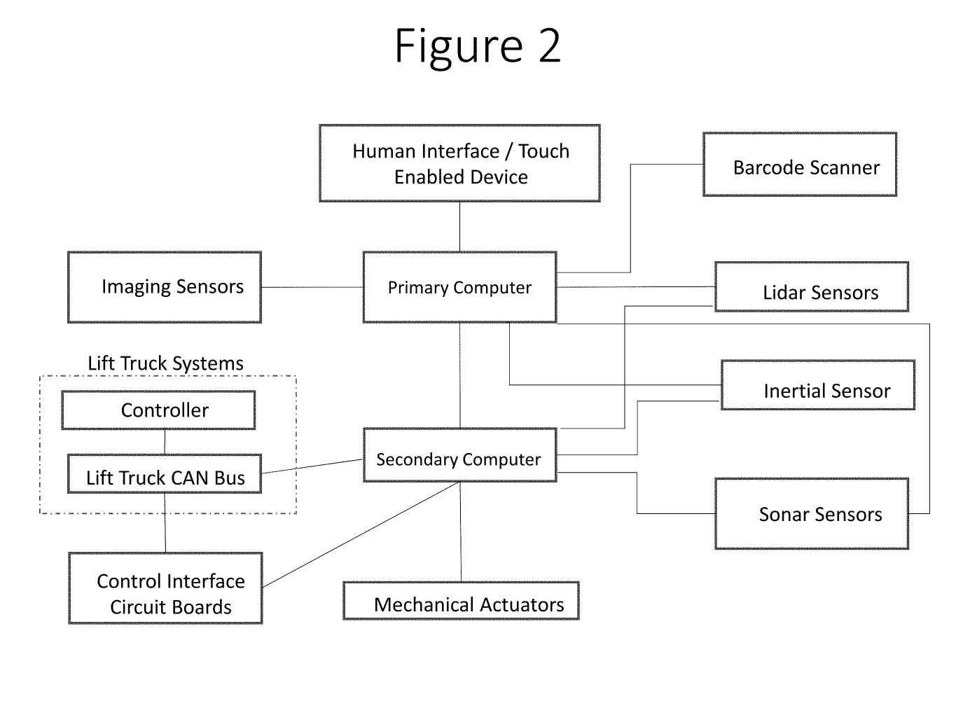

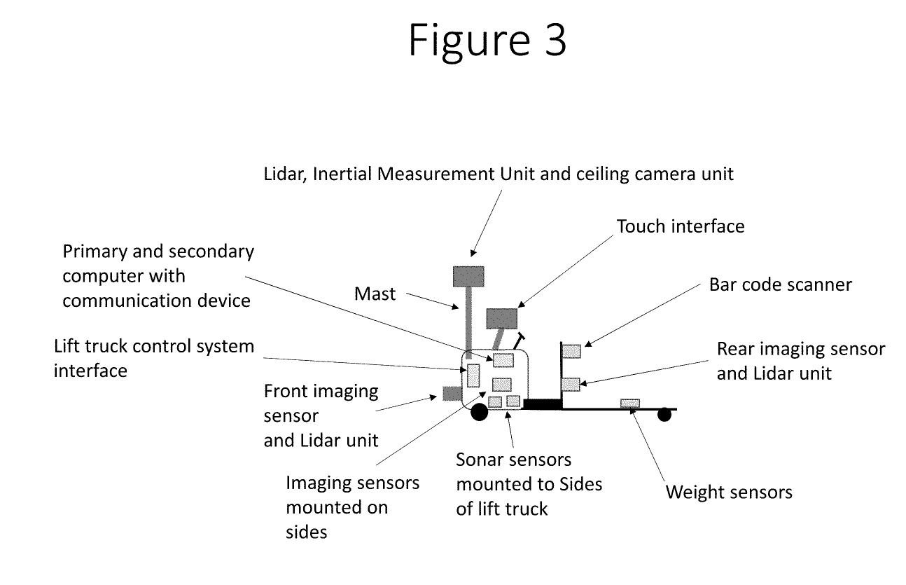

FIG. 2 shows a block diagram of exemplary retrofit kit components and how they are interconnected for the purposes of sharing data. FIG. 3 shows an example (embodiment) of how the retrofit kit components are mounted on a center rider pallet jack type lift truck.

In one exemplary embodiment, the facility mapping process includes 3 steps:

A human operator switches on the vehicle, selects the mapping mode using a touch enabled interface and drives the vehicle around the facility where it needs to operate. At this time the vehicle is gathering and storing sensor data.

Once the data gathering process is complete, the operator selects the build map mode and the vehicle processes the data on its onboard computer to formulate a map. Once the processing is complete, the data and processed map is uploaded to a remote server via a wireless link.

A human operator reviews the uploaded map, if issues are detected they are fixed manually and the map is then approved. Once the map is approved, all other retrofitted lift trucks in a fleet are adapted to download and use the map via a wireless link.

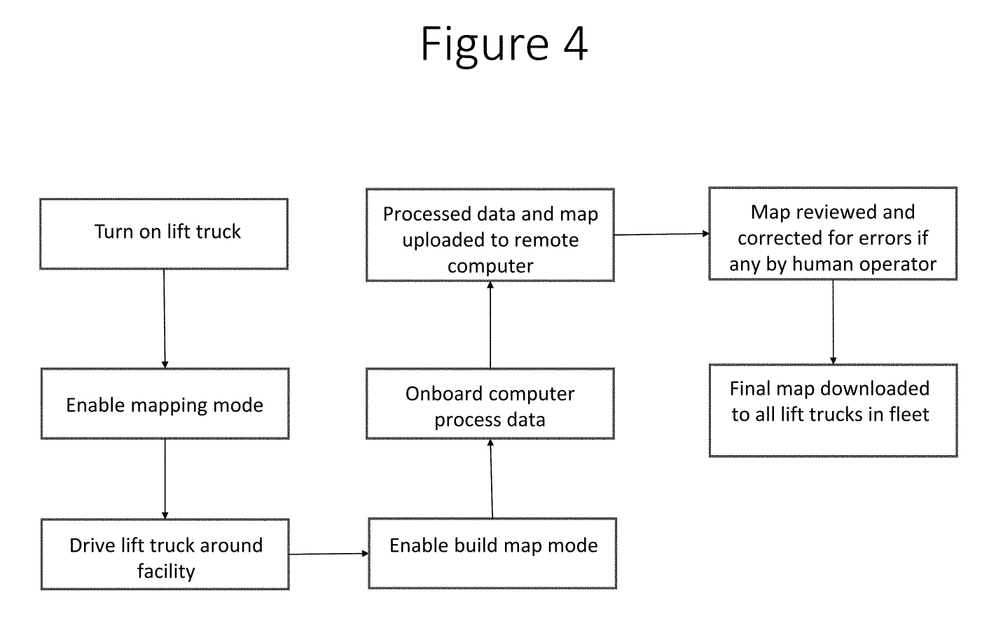

Once the map is constructed, different areas of the map can be labelled manually to reflect keep-out zones where the lift truck may not operate, charger location, pallet drop off zones, aisle numbers etc. These labels can allow material handling tasks to be defined as missions via user selection of appropriate pick and drop off points for each mission. FIG. 4 shows the mapping process flow diagram.

Reference [1] develops a method to compute map information from laser range scan data, which can be used to implement various aspects of the present disclosure, and which is hereby incorporated by reference as if set forth herein in its entirety.

Switching Between Manual and Autonomous Operation

A touch enabled interface can be integrated in an easy to reach position for a human operator. A human operator can choose between manual operation and autonomous operation. A human operator can also use a physical switch to disengage software control. Multiple physical e-stop switches can also be provided, which if activated, immediately bring the vehicle to a halt and disengages software control.

In autonomous mode, missions can be defined for the lift truck including:

Point to point navigation.

Dropping off a pallet at a chosen destination on the map.

Pick up of a pallet from a location defined on the map.

Storing, Communicating and Processing of Data for Learning

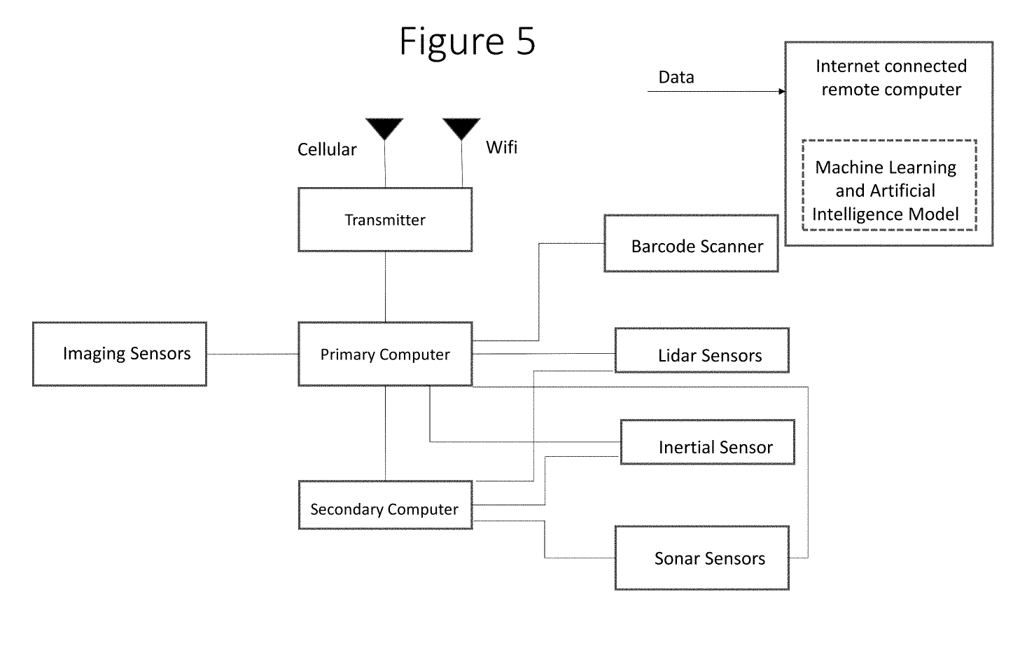

The sensors and integrated circuits in the retrofit kit are configured to gather images, laser scan data, vehicle diagnostics, position and inventory information. This information can be stored and uploaded to a remote server or other suitable systems or devices. Machine learning and artificial intelligence algorithms can be trained on the captured data to improve object recognition capability. Once a new artificial intelligence model is trained, its parameters can be sent back to all lift trucks in the fleet to improve their ability to process data that defines the environment. FIG. 5 shows how sensor data is uploaded to a remote server to train artificial intelligence models in one exemplary embodiment.

Camera feed, range information to obstacles and inertial measurement unit data can be processed on-board to detect and warn human operators of an impending accident. In case an accident occurs, all sensor data prior to and just after the accident can be stored on the lift truck and uploaded to a remote server via a wireless link or in other suitable locations. This configuration allows a human operator to determine the root cause of the accident.

For a lift truck in manual mode, the method of accident warning and detection works as follows:

An early warning distance zone can be defined around the lift truck virtually in software.

A danger warning distance zone can be defined around the lift truck virtually in software.

If an obstacle is detected via range measurements to be within the early warning zone, the operator can be alerted via audio-visual cues or in other suitable manners.

If an obstacle is detected within the danger zone around the lift truck through obstacle detection sensor measurements (such as sonar, cameras, Lidar etc.), the driver can be notified with repetitive visual and auditory cues and the forklift speed is limited to a maximum pre-set value or in other suitable manners.

If an accident is detected from the inertial sensor measurements, i.e., the rate of change of acceleration exceeds a pre-set threshold, an incident is reported to a remote server via a wireless link or in other suitable manners.

For a lift truck in autonomous mode, the method of accident warning and detection can work as follows, in one exemplary embodiment:

An early warning distance zone is defined around the lift truck virtually in software.

A danger warning distance zone is defined around the lift truck virtually in software which is smaller than the early warning danger zone.

If an obstacle is detected via range measurements to be within the early warning zone, the vehicle starts slowing down.

If an obstacle is detected to be within the danger zone then the vehicle immediately comes to a stop.

A camera pointed towards the driver's cabin captures images of driver behavior and compares that in-built safe operation behavior. If an anomaly is detected, the driver is warned with an audio-visual cue and this information is logged in a safety report and sent to a remote computer via a wireless link.

On board sensors and integrated circuits are configured to read vehicle diagnostic messages and process sensor information to compute vehicle speed and position within the facility or in other suitable locations. This information can be relayed in real-time to a remote computer where a human operator can be notified of a maintenance issue or violation of safe driving rules by a human operator, e.g., if the operator exceeds a speed or turn rate limit.

The vehicle diagnostics information is available through a CAN bus interface or other suitable interfaces. An integrated circuit is plugged into the CAN bus to read diagnostics information, or other suitable devices can also or alternatively be used. The position of the vehicle can be calculated by comparing the measurements from a range sensing device to the pre-built map. Vehicle velocity is estimated by reading speed information from the CAN bus or in other suitable manners.

Software capabilities can be developed at a different site than where the robot operates. If a new software capability is developed that is to be sent to retrofitted lift trucks operating in the physical world, the following exemplary process or other suitable processes can be followed:

The software update is sent to a remote server via an internet link.

The remote server then contacts the primary computer mounted on lift truck through a wireless link and informs it that a software update is available.

The primary computer mounted on the lift truck downloads the software update and stores it in memory.

When the lift truck is stationary and charging, the software update is applied and the computers are automatically rebooted.

If an issue is detected during reboot, the secondary computer alerts nearby human operators with an audio-visual warning.

The secondary computer connects to the CAN bus interface of the lift truck, directly to the battery gauge if a CAN bus is not available, or in other suitable manners, to read the battery voltage and for other suitable purposes. If the battery voltage is detected to be lower than a pre-set threshold, the processors of the vehicle can detect that it needs to return to its charging station. If a vehicle is in the middle of a mission, the processors of the vehicle or other suitable systems or devices can estimate the energy it will take to complete the mission, and if sufficient battery energy is available to complete the mission, the lift truck can first complete the mission and return to the charging location as defined on the map. If there is insufficient power to complete the mission, the vehicle can navigates to the closest safe zone and stops, or can take other suitable actions. The vehicle processor can then alert nearby human operators with audio-visual cues or in other suitable manners to return the lift truck to charging manually. The vehicle can also alert a remote operator via a wireless link.

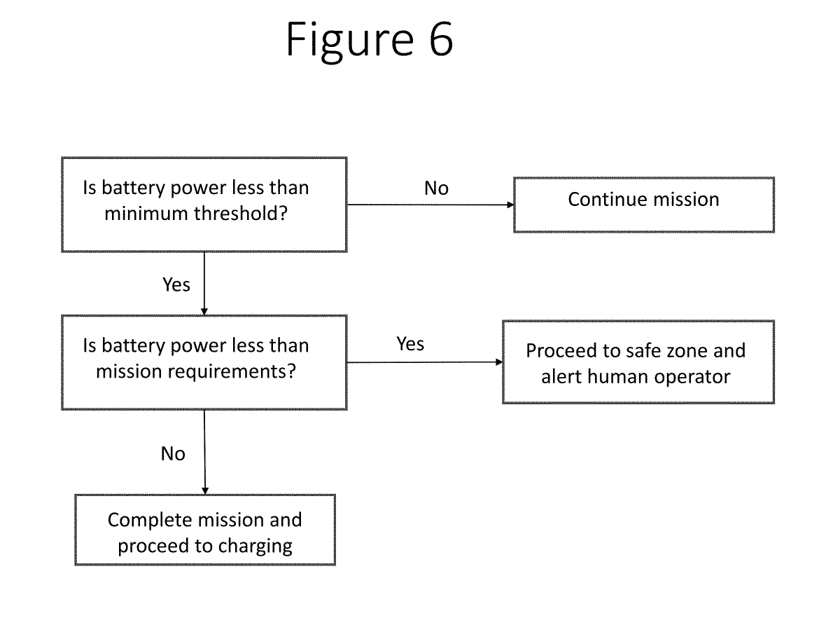

Before starting every mission, the on-board computer can computes the battery power required to complete the mission and the battery power available. If the battery power available is less than what is required, it can reject the mission and return the lift truck to the charging station. FIG. 6 shows the automatic docking process for charging.

Camera sensors and range measurement devices such as LiDAR, sonar or other suitable devices or systems enable the on-board computer to detect obstacles in the path of vehicle. If an obstacle is detected near the vehicle, the camera feed can be used to compare the obstacle to a known database of objects. Objects can be classified in two categories; (i) safe to travel around, (ii) not safe to travel around, or other suitable categories can also or alternatively be used.

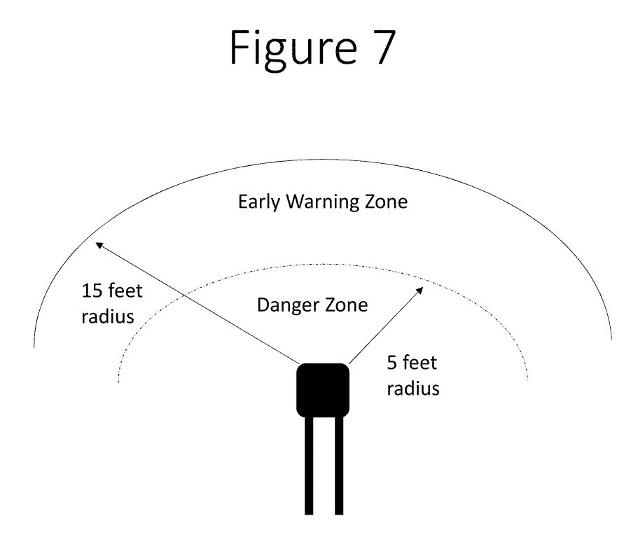

If the object is identified to be not safe to travel around, the lift truck can be commanded to stop by the computer till the path becomes clear, or other suitable instructions can be generated and implemented. If the software operating on the processor is not able to match the obstacle to a known class of objects with a high confidence (>95%) then the vehicle can be instructed to stop and to wait until the object clears the path. In other cases, the on-board computer can compute a new path to its destination and command the lift truck to follow the new path and avoid the obstacle. FIG. 7 gives an exemplary visual description of how the obstacle detection system can work.

The on-board software may not have certain capabilities pre-programmed. These may include tasks such as but not limited to:

Pallet pick-up from the ground.

Pallet drop-off onto a rack.

Pallet retrieval from a rack.

Trailer loading and unloading.

Planning a new path around an unknown obstacle.

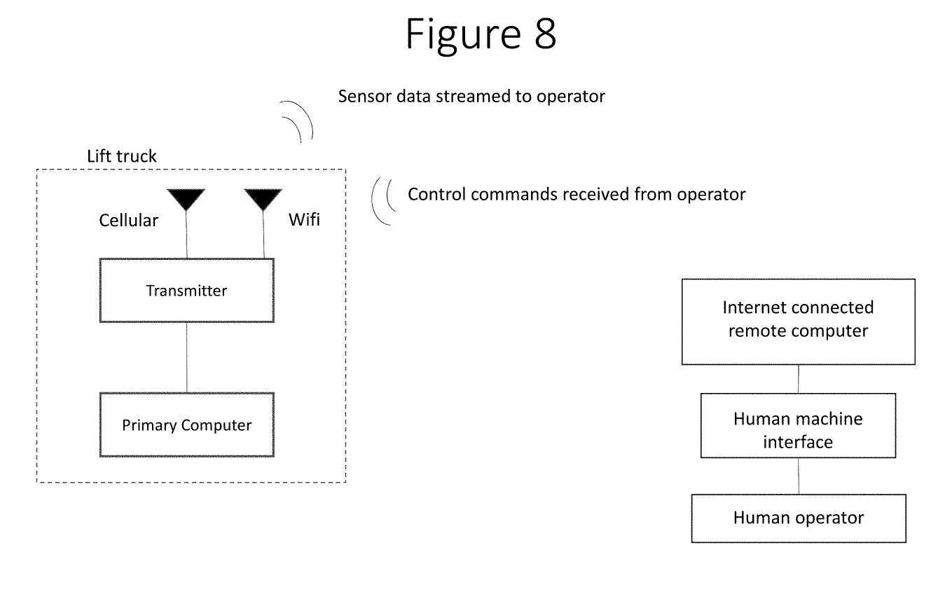

If a lift truck needs to carry out a task which it is not pre-programmed for, it can contact a remote operator via a wireless link. The wireless link can be through a local wifi network or cellular. Once a remote operator is connected to the lift truck, the operator can view the real-time sensor feed using screens or a wearable head mounted device to perceive the environment. Using joystick controls, touch enabled interface or a physical interface that mimics the control system on the lift truck, the remote operator can control the lift truck including driving and lifting mechanisms. The operator can drive the lift truck for an entire mission, complete the complex task and hand over driving control back to the autonomous driving software, or other suitable processes can also or alternatively be performed. FIG. 8 shows an exemplary block diagram for how a remote operator can control a lift truck via a wireless link.

A bar code, NFC, RFID or other suitable device scanner or other suitable device can be mounted on the mast or fork assembly or in other suitable locations such that it can scan bar code labels attached to goods that will be moved. In either manual or autonomous mode, once the lift truck starts approaching a pallet to be picked up, the on-board computer uses range sensing from LiDAR or sonar and camera based systems to detect that an item is to be picked up. When an item is being picked up, the on-board software enters the “pick-up state” which is virtually defined in software. If in manual operation mode, the on-board computer may choose to confirm the “pick-up state” with a visual cue on a touch enabled device.

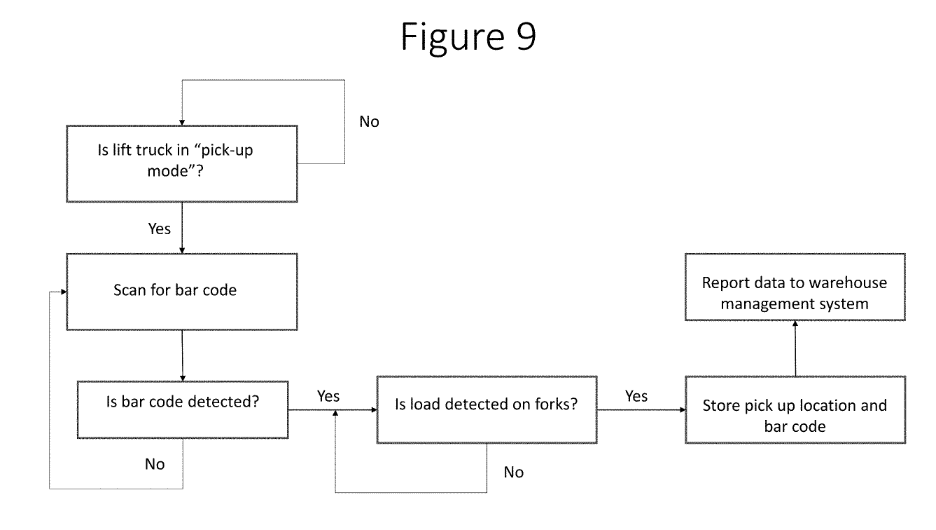

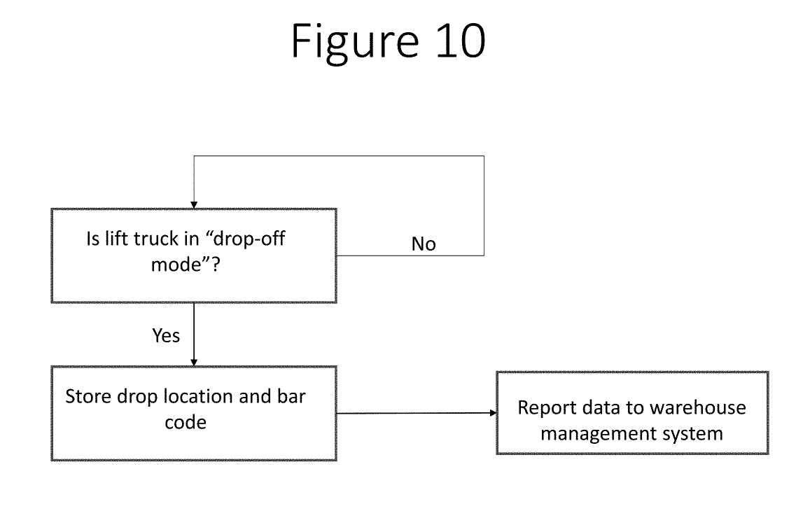

In the pick-up sate, the bar code scanner makes repeated scans till a bar code is detected. The weight sensor on the forks alerts the on-board computer that the pallet has been picked up. Once the pallet is picked up, the on-board computer relays the bar code of the picked-up item along with the location where it was picked up to the inventory management system. If a lift truck is in autonomous mode, it may use bar code data to decide where to drop off pallet. Once the goods are dropped off to another location, the weight sensor detects that the goods are no longer present. The on-board computer relays the bar code of the goods dropped off along with the drop location to the inventory management system which updates its records. FIGS. 9 and 10 show how the retrofit kit enables inventory tracking.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations.

Many variations and modifications may be made to the above-described embodiments without departing from the principles of the present disclosure. All such modifications and variations are intended to be included herein within the scope of this disclosure and protected by the following claims.

What is claimed is:

1. A method to retrofit industrial lift trucks for automated material handling, comprising:
switching on a vehicle, selecting a mapping mode using a touch enabled interface and driving the vehicle around a facility where it needs to operate, wherein the vehicle gathers and stores sensor data;
selecting a build map mode after the vehicles gathers and stores sensor data;
formulating a map;
uploading the data and the map to a remote server via a wireless link;
distributing the map to other retrofitted lift trucks in a fleet; and
defining a missions via user selection of appropriate pick and drop off points from the map.
